(19) United States
(12) Patent Application Publication
(10) Pub. No.: US 2012/0231789 A1
(43) Pub. Date: Sep. 13, 2012

(54) Method and System for SIM Card Reregistration Control in a Mobile Communications Network

(76) Inventors: Yakov Kharon, Moscow (RU); Roman Rozenberg, Brooklyn, NY (US)

(21) Appl. No.: 13/044,131

(22) Filed: Mar. 9, 2011

(51) Int. Cl. H04W 8/06

(52) U.S. Cl. 455/433

(57) ABSTRACT

A method for registering a mobile terminal on a mobile telecommunications network includes leaving an operating range of a primary mobile telecommunications network. Data is received from other mobile telecommunications networks. A list of available mobile telecommunications network is determined. It is determined whether a mobile virtual network operator managed by the primary telecommunications network is available. When it is determined that a mobile virtual network operator managed by the primary telecommunications network is available, the virtual network operator is selected as a guest network, IMSI and MSISDN information received from the guest network is stored to a SIM card of the mobile terminal, and messages are exchanged between the mobile terminal and the guest network.

### BACKGROUND OF THE INVENTION

1. Technical Field

The present disclosure relates to mobile communications and, more specifically, to a method and system for SIM card registration control in a mobile communications network.

2. Discussion of Related Art

Mobile telephones designed for operation on networks such as those based on Global System for Mobile Communications (GSM) and Universal Mobile Telecommunications System (UMTS) utilize a form of a Subscriber Identity Module (SIM) to authorize the mobile telephone on the network with the account credentials of a particular subscriber. The SIM may be embodied as a removable smart card such as the Universal Integrated Circuit Card (UICC). SIM cards for UMTS networks are known as Universal Subscriber Identity Modules (USIMs), however, these cards may be colloquially referred to as SIM cards as well. Other forms of wireless networks may also utilize corresponding subscriber identification cards. For example, wireless networks such as those based on Code Division Multiple Access (CDMA) may utilize a Removable User Identity Module (R-UIM), which may also colloquially be referred to as a SIM, although the use of R-UIMs in such networks is for the time being less than ubiquitous.

By embodying the SIM on a removable card, mobile network subscribers may easily activate any compatible mobile communications device on their subscribed network simply by installing their SIM card into the chosen mobile communications device.

Mobile communications devices operating on mobile networks are most commonly mobile telephones, however, other devices such as personal computers, tablets, Personal Digital Assistants (PDAs), smartphones, digital media players, portable video game consoles, eBook readers, wireless modems and the like may also be equipped with SIM card readers for accepting a SIM card and gaining access to a mobile network. Some mobile communications devices such as mobile telephones may also include multiple SIM card readers for accepting multiple SIM cards thereby allowing the device to gain access to one or more mobile networks and send and receive calls and/or data from multiple accounts and/or telephone numbers.

When a mobile communications device is transported beyond the subscribed network, service may be maintained by handing off network access to a different mobile network. When operating within a different network, the mobile communications device is said to be in a state of “roaming.” The act of roaming may incur additional expenses to the subscriber and/or the subscribed network.

U.S. Pat. No. 6,603,968 of Aug. 5, 2003, incorporated herein by reference, relates to a telecommunications method that includes providing roaming and SIM card reregistration services as a mobile communications device, such as a mobile telephone, moves out of the operating range of a first radio network into the operating range of a second radio network. Here, the phone is re-registered using local roaming-related information for the cell-phone in the roaming area with reference to the home roaming-related information.

Such an approach relies on roaming to provide wireless network server for as long as the wireless device remains beyond the range of the subscribed network and within the operating range of other networks.

Another approach, such as that provided in GB Patent No. 2,378,097 of Jan. 29, 2003, entitled “Re-registration of a SIM card with a visited network to make it the SIM cards temporary new home network,” incorporated herein by reference, relates to a method for controlling reregistration of a SIM card as the mobile communications device moves out of the operating range of one radio network into the operating range of another radio network.

Another prior art invention known from GB Patent No. 2,378,097 of Jan. 29, 2003 entitled “Re-registration of a SIM card with a visited network to make it the SIM cards temporary new home network.” According to this approach, a plurality of different predetermined networks may be accessed by a plurality of terminals having smart cards. Each terminal is operable in a first (“home network”) in association with one of the smart cards when that smart card is registered with the home network and is operable in at least a second (“visited network”) pursuant to an agreement between the visited network and the home network under which authentication of the smart card when the terminal is operative in the visited network is controlled by the home network. This approach includes the step of temporarily registering the smart card with the visited network as its new home network whereby authentication of the smart card when the terminal is operative in the visited network as its new home network is controlled by the visited network. This approach for controlling SIM card reregistration relies on both mobile networks being controlled by and belonging to a common owner, or another similar arrangement.

### SUMMARY

A method for registering a mobile terminal on a mobile telecommunications network includes leaving an operating range of a primary mobile telecommunications network to which the mobile terminal is subscribed. Data is received from one or more other mobile telecommunications networks. A list of available mobile telecommunications network is determined from the received data. It is determined whether a mobile virtual network operator managed by the primary telecommunications network is available from among the list of available mobile telecommunications networks. When it is determined that a mobile virtual network operator managed by the primary telecommunications network is not available, the mobile terminal establishes a roaming arrangement with one of the mobile telecommunications networks of the determined list of mobile telecommunications networks and when it is determined that a mobile virtual network operator managed by the primary telecommunications network is available, the virtual network operator is selected as a guest network, IMSI and MSISDN information received from the guest network is stored to a SIM card of the mobile terminal, and messages are exchanged between the mobile terminal and the guest network.

Registration of the SIM card may be controlled by the mobile virtual network operator. The mobile virtual network operator may include a plurality of servers, each connected to a switchboard of the primary mobile telecommunications network, and a managing server connected through one or more of the plurality of servers to the switchboard of the primary mobile telecommunications network. The managing server may be supplied with a telephone number of the mobile terminal and is responsible for directing telephone calls to the mobile terminal via the mobile virtual network operator using the switchboard.

The mobile terminal is a cellular telephone. Alternatively, the mobile terminal may be a portable computer, a smartphone, a personal digital assistant (PDA), a tablet computer, a portable media player (PMP), or a wireless modem.

A method for registering a mobile device on a mobile telecommunications network includes controlling SIM card reregistration upon movement of a mobile terminal out of an operating range of one radio network into an operating range of another radio network. SIM cards are reregistered by a mobile virtual network operator using a plurality of servers, each of which is connected to a switchboard of a basic operator of the one radio network, and a managing server that supplies a request of the mobile terminal for reregistration of a SIM card thereof to one or more of the plurality of servers connected to the switchboard of the basic operator of the one radio network.

The basic operator of the one radio network may include data received by the mobile device. The managing server may keep records of mobile terminal registrations in a plurality of radio networks to which the servers of the network operator are connected. The mobile terminal may be a cellular telephone. Alternatively, the mobile terminal may be a portable computer, a smartphone, a personal digital assistant (PDA), a tablet computer, a portable media player (PMP), or a wireless modem.

A telecommunications system includes a plurality of radio networks and a plurality of mobile terminals, each having a SIM card. Reregistration of SIM cards of the mobile terminals are provided as the mobile terminals move out of an operating range of one radio network of the plurality of radio networks, into an operating range of another radio network of the plurality of radio networks. The system further includes a mobile virtual network operator having a plurality of servers, each connected to a switchboard of a basic operator of one of the plurality of radio networks, and a managing server that is connected through communication channels to each of the other servers of the plurality of servers of the mobile virtual network operator. The mobile virtual network operator is enabled to receive and transmit requests of the mobile terminals for SIM card reregistration to the servers connected to the switchboard of the basic radio network operator.

The basic operator may include data received by the mobile device. One of the plurality of servers of the mobile virtual network operator may be connected to the switchboard of the basic operator of each radio network, and the managing server may be enabled to receive and transmit telephone requests for SIM card reregistration to the one of the plurality of servers connected to the switchboard of the basic operator of the radio network.

The system may further include a plurality of mobile virtual network operators each including a plurality of respective servers, each of which is connected to the switchboard of the basic operator of one of the radio networks, and each including a respective managing server connected through communication channels to each of the other servers and enabled to receive and transmit telephone requests for SIM card reregistration to the server connected to the switchboard of the basic operator of the radio network.

The mobile terminal may be a cellular telephone. Alternatively, the mobile terminal may be a portable computer, a smartphone, a personal digital assistant (PDA), a tablet computer, a portable media player (PMP), or a wireless modem.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a diagram illustrating a telecommunications systems having a mobile virtual network operator according to an exemplary embodiment of the present invention;

FIG. 2 is a flow chart illustrating a method for controlling SIM card registration within a telecommunications network according to an exemplary embodiment of the present invention; and

FIG. 3 and FIG. 4 are tables illustrating the recording of telephone registrations by the server of a mobile virtual network operator connected to the switchboard of the basic operator of one of the radio networks for which the aforesaid network is a guest network according to an exemplary embodiment of the present invention.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention may permit complete or partial abandonment of roaming in accordance with roaming contracts made between network providers. According to at least one exemplary embodiment of the present invention, a subscriber's home network may operate as a mobile virtual network operator (MVNO) with respect to one or more visited networks. Accordingly, existing infrastructure of other (basic) network operators and/or services thereof may be sold or leased to the subscriber's home network operator independently. The mobile virtual network operator may use the radio network and switchboards in common with the basic operator. For example, a first mobile network provider may register as a MVNO on the network of a second mobile network provider that may operate in a different geographic region, e.g. country.

This reliance on the mobile virtual network operator in different countries may simultaneously help to dispense with roaming procedures in those countries and, accordingly, costs to subscribers may be significantly reduced.

Accordingly, rather than permitting a subscriber's mobile phone to connect with and utilize any visited network which the roaming subscriber happens to find himself within the coverage of, exemplary embodiments of the present invention may permit the roaming mobile phone to access only those networks that the subscriber's home network maintains as a MVNO. In this regard, the SIM card of the subscriber's mobile telephone may be connected in a cost-efficient manner.

The mobile telephone, so configured, may also register to roaming cellular phones when no MVNO maintained by the subscriber's home network operator is available. Accordingly, roaming and SIM card reregistration services may be provided as the cellular telephone moves out of the operating range of a first radio network into the operating range of a second radio network, provided that SIM card reregistration is controlled by the mobile virtual network operator. MVNO service may be provided over the infrastructure, including servers and switchboards, of the basic operator of one of the radio networks.

The subscriber's basic network operator, which the subscriber maintains a subscription with, may operate the MVNO using some of the infrastructure of the remote network, but may use its own switching hardware to actually connect and manage telephone calls routed to the subscriber over the remote MVNO. For example, a managing server may be used to connect the roaming subscriber with the switchboard of the basic operator and the telephone conversation of the subscriber may be routed through the switchboard of the basic operator. However, where the subscriber is not within the home network or remote MVNO of the basic operator, standard roaming procedures may be relied upon. In either case, after SIM card reregistration, the roaming network may be utilized as a home network.

Exemplary embodiments of the present invention may also provide a method for controlling SIM card reregistration upon movement of a cellular telephone out of the operating range of one radio network into the operating range of another network by the mobile virtual network operator using servers, each connected to the switchboard of the basic operator of one of the radio networks, and a managing server that receives and distributes the request from each telephone for SIM card reregistration to the server connected to the switchboard of the basic operator of the radio network the data on which have been communicated by the telephone.

In this event, the managing server can keep records of telephone registrations in all radio networks to which the servers of the cellular network operator are connected.

Exemplary embodiments of the present invention may provide for a telecommunications system including several radio networks and cellular telephones. The system may reregister the SIM card of a telephone moving out of the operating range of one radio network into the operating range of another radio network. A mobile virtual network operator may have servers, each of which may be connected to the switchboard of the basic operator of one of the radio networks. A managing server may be connected through communication channels to each of the other servers of the mobile virtual network operator. The managing server may be enabled to receive and transmit telephone requests for SIM card reregistration to the server connected to the switchboard of the basic operator of the radio network.

The server of the mobile virtual network operator may be connected to the switchboard of the basic operator of each radio network, in which case the managing server is enabled to receive and transmit telephone requests for SIM card reregistration to the server connected to the switchboard of the basic operator of the radio network the data on which are contained in a telephone request.

The system may include several mobile virtual network operators, each having its own servers, each connected to the switchboard of the basic operator of one of the radio networks, and each having its own managing server connected through communication channels to each of the other servers. Each of the MVNOs may be enabled to receive and transmit telephone requests for SIM card reregistration to a server connected to the switchboard of the basic operator of the radio network.

Exemplary embodiments of the present invention may be used to control telecommunications for a subscriber traveling in different countries within the operating range of different radio networks. Mobile virtual network operators may utilize the radio network of a basic operator (for example, Corbina Telecom, Matrix Telecom, and A-Mobile). Unlike these common uses of a mobile virtual network operator, exemplary embodiments of the present invention may use the system of a mobile virtual network operator in common with different basic radio networks. Accordingly, multiple home networks from different regions may share a single MVNO operating in a remote region to handle call traffic instead of relying upon roaming procedures.

The system of a single virtual operator in accordance with exemplary embodiments of the present invention may control the telecommunications of its subscribers traveling from one country to another, out of the operating range of one radio network into the operating range of another radio network. For this purpose, the telephone, or, more accurately, its SIM card, contains a database of the radio networks of basic operators and is enabled to identify radio networks having switchboards to which the server of the virtual operator is connected.

In addition, messages may be exchanged directly between the managing server of the virtual operator and a cellular telephone, or a subscriber. These messages may be implemented, for example, in the form of Short Message Service (SMS) messages that a cellular telephone sends directly to, and receives from, the managing server of the virtual operator.

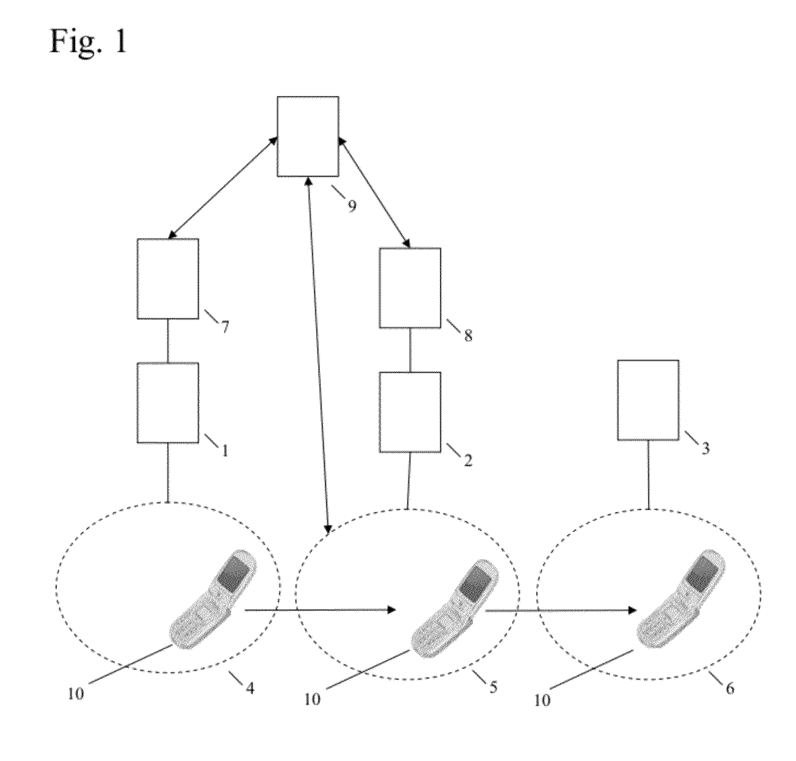

FIG. 1 shows a telecommunications systems having a mobile virtual network operator according to an exemplary embodiment of the present invention. Here, objects 1, 2, and 3 represent switchboards of different basic operators of cellular networks, and objects 4, 5, and 6 represent radio networks of these basic operators. Objects 7 and 8 represent servers of the mobile virtual network operator that are connected to switchboards 1 and 2. Object 9 represents a managing server of the mobile virtual network operator connected to servers 7 and 8. A telephone, or other cellular network terminal, mobile communications device, or network-enabled computing device, 10 is within the operating range of the radio network 5. The mobile telephone 10 is depicted as having moved out of the operating range of its home network 4. When the telephone 10 detects that it is outside the operating range of the radio network 4 and is within the operating range of a different radio network 5, the telephone 10 sends a message, such as an SMS message, to managing server 9 containing data (e.g. Network ID) identifying the radio network 5. The managing server 9 sends data identifying telephone 10 to server 8 that, in common with switchboard 2 and radio network 5 of the basic operator, communicates new data to the telephone 10 for reregistering the SIM card thereof and accordingly, the radio network 5 may become the home network of the telephone 10 for the duration of its presence therein.

Then, when the telephone 10 moves into the operating range of the next radio network 6, telephone 10 sends an SMS message to the managing server 9 containing data (e.g. Network ID) identifying radio network 6. The managing server 9 establishes which of the radio networks (in particular, two radio networks 4 and 5) used as the home network by the telephone 10 may use roaming procedures in the radio network 6 at a minimal cost. Next, the managing server 9 sends data identifying the telephone 10 to the server that, in common with the switchboard of the radio network chosen, communicates new data to the telephone 10 for reregistering the SIM card thereof. The telephone 10 may then use roaming procedures for operating in the radio network 6.

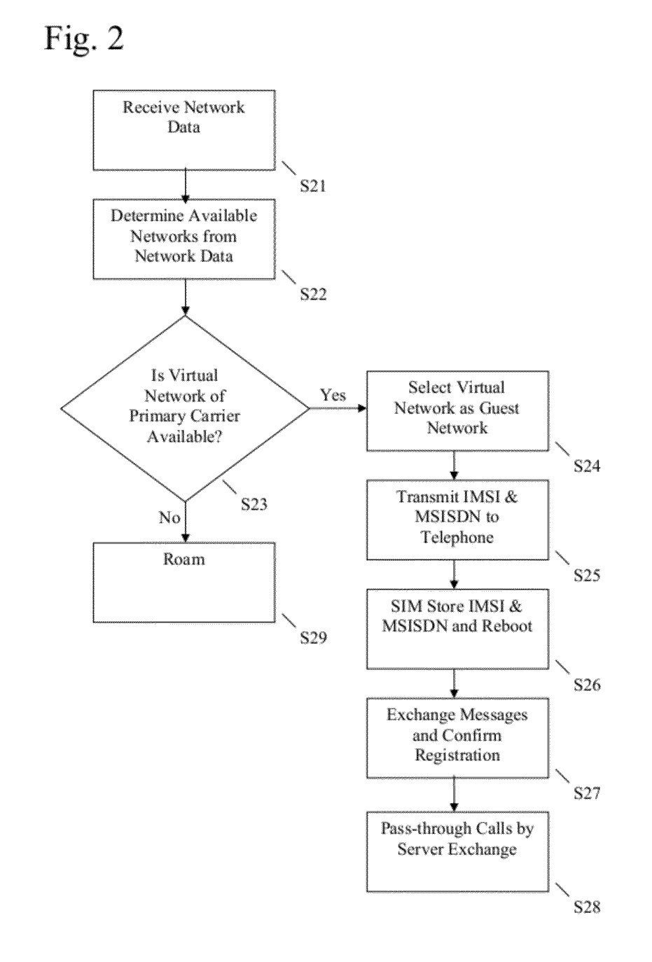

FIG. 2 is a flow chart illustrating a method for controlling SIM card registration within a telecommunications network according to an exemplary embodiment of the present invention.

First, the cellular telephone may receive, for example from usual radio broadcasts, network data (e.g. Network ID), that establishes to the cellular telephone that it is operating outside of the home network (Step S21). Then, the cellular telephone may determine the network(s) that it is operating within based on the received network data (Step S22). The cellular telephone may then compare the available network with a database of guest networks for which the cellular telephone's primary service carrier is a virtual operator of to determine whether a virtual network of the primary service carrier is available (Step S23).

If a virtual network of the primary service carrier is available (Yes, S23), then the cellular telephone may then select a guest network from among the networks that it is operating within that are also virtually operated by the primary service carrier (Step S24). The cellular telephone may then transmit data on the guest network to a managing server of the virtual operator using any accessible transfer protocol such as the Unstructured Supplementary Service Data (USSD) (which may be implemented subject to prior arrangement), SMS, and/or GPRS. Next, the virtual operator may transmit an International Mobile Subscriber Identity (IMSI) and a Mobile Station Integrated Services Digital Network (MSISDN) Number to the telephone (Step S25). The Kei and other data related to the network may also be transmitted to the telephone, either along with the IMSI and MSISDN or separately. The SIM card of the cellular telephone may then store the new IMSI, MSISDN (along with the Kei and other data) and may then reboot and/or take other steps necessary to implement the change of network (Step S26). The cellular telephone may then exchange messages with the virtual operator (guest network) confirming registration (Step S27). In this way, the guest network may become a new temporary home radio network to the mobile telephone. The servers of the virtual operator may then exchange information with the managing server about the telephone reregistration so that calls may be allowed to pass through from within the range of one radio network to within the range of another network (Step S28).

If, however, a virtual network of the primary service carrier is not available (No, S23), then the cellular telephone determines a best guest network to roam on (Step S29). The managing server of the virtual operator may be used to establish which of the available radio networks (to which the server of the virtual operator is connected) may be used as the home network by telephone. Roaming procedures may be used to establish the connection and a network with minimal roaming costs may be selected as the best guest network. Here, the managing server may send data identifying the cellular telephone to the server that, in common with the switchboard of the home network chosen, communicates new data to the cellular telephone for reregistering the SIM card thereof. The cellular telephone may use ordinary roaming procedures for operation in the guest radio network.

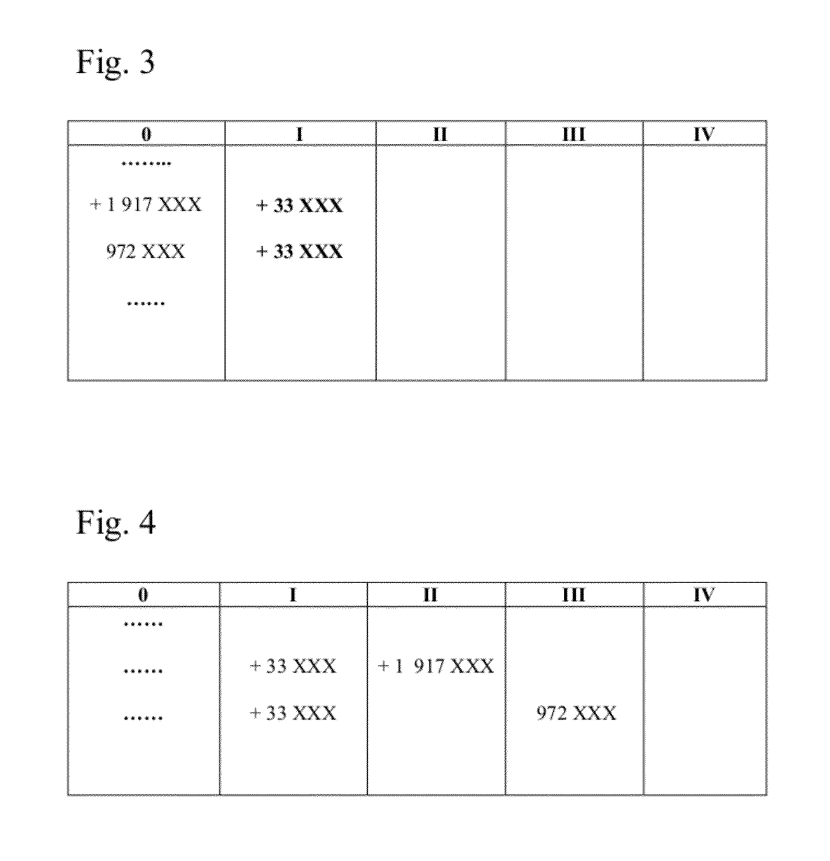

FIG. 3 and FIG. 4 show tables for the recording of telephone registrations by the server of a mobile virtual network operator connected to the switchboard of the basic operator of one of the radio networks for which the aforesaid network is a guest network according to an exemplary embodiment of the present invention. It is to be understood that records are given in tabulated form for convenience, and that the server may actually use a different record form.

The first column of FIG. 3 (column “0”) shows telephone numbers corresponding to their “home registration.” The other columns I, II, III, and IV each represent a different basic operator and radio network. For example, with basic operators II and III that have been communicated by the managing server to the aforesaid server. In accordance with these messages, the server in the second column of the table activates the telephone numbers of basic operator Ito the switchboard of which the server is connected.

After the telephone has moved into the operating range of another radio network, for example, that of basic operator IV, the managing server communicates the change to the server the record table of which is referred to here, and the telephone numbers, as shown in the second column of FIG. 4, will be deactivated, and the numbers will move from the first column to the column of the respective basic operator. Subsequently, as these telephones move into the operating range of basic operator I again, numbers will be assigned to them; for example, the telephone numbers in the second column will be activated.

Each server of the virtual operator may keep detailed records and may communicate the record data to the managing server. In this way, the managing server stores information about each telephone of the mobile virtual network operator.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for registering a mobile terminal on a mobile telecommunications network, comprising:
leaving an operating range of a primary mobile telecommunications network to which the mobile terminal is subscribed;
receiving data from one or more other mobile telecommunications networks;
determining a list of available mobile telecommunications network from the received data;
determining whether a mobile virtual network operator managed by the primary telecommunications network is available from among the list of available mobile telecommunications networks;
when it is determined that a mobile virtual network operator managed by the primary telecommunications network is not available, the mobile terminal establishes a roaming arrangement with one of the mobile telecommunications networks of the determined list of mobile telecommunications networks; and
when it is determined that a mobile virtual network operator managed by the primary telecommunications network is available, the following steps are performed:
selecting the virtual network operator as a guest network;
storing International Mobile Subscriber Identity (IMSI) and Mobile Station Integrated Services Digital Network (MSISDN) information received from the guest network to a Scriber Identity Module (SIM) card of the mobile terminal; and
exchanging messages between the mobile terminal and the guest network.

2. The method of claim 1, wherein registration of the SIM card is controlled by the mobile virtual network operator.

3. The method of claim 1, wherein the mobile virtual network operator comprises:
a plurality of servers, each connected to a switchboard of the primary mobile telecommunications network; and
a managing server connected through one or more of the plurality of servers to the switchboard of the primary mobile telecommunications network,
wherein the managing server is supplied with a telephone number of the mobile terminal and is responsible for directing telephone calls to the mobile terminal via the mobile virtual network operator using the switchboard.

4. The method of claim 1, wherein the mobile terminal is a cellular telephone.

5. The method of claim 1, wherein the mobile terminal is a portable computer, a smartphone, a personal digital assistant (PDA), a tablet computer, a portable media player (PMP), or a wireless modem.

6. A method for registering a mobile device on a mobile telecommunications network, comprising:
controlling SIM card reregistration upon movement of a mobile terminal out of an operating range of one radio network into an operating range of another radio network,
wherein SIM cards are reregistered by a mobile virtual network operator using:
a plurality of servers, each of which is connected to a switchboard of a basic operator of the one radio network, and
a managing server that supplies a request of the mobile terminal for reregistration of a SIM card thereof to one or more of the plurality of servers connected to the switchboard of the basic operator of the one radio network.

7. The method of claim 6, wherein the basic operator of the one radio network includes data received by the mobile device.

8. The method of claim 6, wherein the managing server keeps records of mobile terminal registrations in a plurality of radio networks to which the servers of the network operator are connected.

9. The method of claim 6, wherein the mobile terminal is a cellular telephone.

10. The method of claim 6, wherein the mobile terminal is a portable computer, a smartphone, a personal digital assistant (PDA), a tablet computer, a portable media player (PMP), or a wireless modem.

11. A telecommunications system comprising:
a plurality of radio networks; and
a plurality of mobile terminals, each having a SIM card,
wherein reregistration of SIM cards of the mobile terminals are provided as the mobile terminals move out of an operating range of one radio network of the plurality of radio networks, into an operating range of another radio network of the plurality of radio networks,
wherein the system further comprises a mobile virtual network operator having a plurality of servers, each connected to a switchboard of a basic operator of one of the plurality of radio networks, and a managing server that is connected through communication channels to each of the other servers of the plurality of servers of the mobile virtual network operator, and
wherein the mobile virtual network operator is enabled to receive and transmit requests of the mobile terminals for SIM card reregistration to the servers connected to the switchboard of the basic radio network operator.

12. The system of claim 11, wherein the basic operator includes data received by the mobile device.

13. The system as claimed in claim 11, wherein one of the plurality of servers of the mobile virtual network operator is connected to the switchboard of the basic operator of each radio network, and the managing server is enabled to receive and transmit telephone requests for SIM card reregistration to the one of the plurality of servers connected to the switchboard of the basic operator of the radio network.

14. The system as claimed in claim 11, further comprising a plurality of mobile virtual network operators each including a plurality of respective servers, each of which is connected to the switchboard of the basic operator of one of the radio networks, and each including a respective managing server connected through communication channels to each of the other servers and enabled to receive and transmit telephone requests for SIM card reregistration to the server connected to the switchboard of the basic operator of the radio network.

15. The system of claim 11, wherein the mobile terminal is a cellular telephone.

16. The method of claim 11, wherein the mobile terminal is a portable computer, a smartphone, a personal digital assistant (PDA), a tablet computer, a portable media player (PMP), or a wireless modem.
